(19) United States
(12) Patent Application Publication
(10) Pub. No.: US 2026/0147664 A1
(43) Pub. Date: May 28, 2026

(54) ACCELERATED INCIDENT RESPONSE AND RECOVERY OPTIMIZATION

(71) Applicant: Kyndryl, Inc., New York, NY (US)

(72) Inventors: Krishnaprasad Padmanaban, Bangalore (IN); Srikanth Kannoth Narayanan, Kerala (IN); Chandrasekaran Jayaraj, Chennai (IN); Hari Suryakanth Jeedigunta, Hyderabad (IN); Umashankar Puduvoyal Balasubramaniam, Chennai (IN)

(21) Appl. No.: 18/962,396

(22) Filed: Nov. 27, 2024

(51) Int. Cl. G06F 11/07

(52) U.S. Cl. CPC G06F 11/0793; G06F 11/079

(57) ABSTRACT

A method includes: collecting, by a computing device, input data related to an information technology infrastructure; performing, by the computing device, sequential analysis on the input data to derive an impact on an incident on the information technology infrastructure; and formulating, by the computer device, recovery solutions of the incident that maps to business parameters.

### BACKGROUND

Aspects of the present invention relate generally to incident response and recovery operations and, more particularly, to a system, method and computer program of accelerated major incident response and recovery optimization to reduce latency.

A major incident (MI) or critical situation (CritSit) results in significant disruption to an organization. It is a highest-impact, highest-urgency incident that affects many users, depriving the organization of one or more crucial services. The major incident or critical situation requires a response beyond the routine incident management process. And in the context of managing major incidents, a solution that adheres to a well-defined methodology is crucial.

### SUMMARY

In a first aspect of the invention, there is a computer-implemented method including: collecting, by a computing device, input data related to an information technology infrastructure; performing, by the computing device, sequential analysis on the input data to derive an impact on an incident on the information technology infrastructure; and formulating, by the computer device, recovery solutions of the incident that maps to business parameters.

In another aspect of the invention, there is a computer program product including one or more computer readable storage media having program instructions collectively stored on the one or more computer readable storage media. The program instructions are executable to: collect correlated machine learning (ML) patterns associated with a system issue; formulate a recovery solution that maps to at least one of service level agreements (SLA) or business continuity parameters; and compile a deployment evaluation score to determine optimal solutions for system recovery based on the system issue and the formulated recovery solution.

In another aspect of the invention, there is system including a processor, a computer readable memory, one or more computer readable storage media, and program instructions collectively stored on the one or more computer readable storage media. The program instructions are executable to: collect input data of an information technology infrastructure; run sequential analysis on health integrators to derive inferences on impact correlations in relation to system issues related to the information technology infrastructure; and formulate a recovery solution of the system issues using the sequential analysis that maps to service level agreements (SLA).

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a flowchart of an exemplary method in accordance with aspects of the invention.

FIG. 6 shows a block diagram in accordance with further aspects of the present invention.

FIG. 7 shows an example sequential analysis inference matrix score in accordance with aspects of the invention.

FIG. 8 shows an example recovery formulation and deployment evaluation scorecard in accordance with aspects of the invention.

FIG. 9 shows a scenario based example of the integration workflow in accordance with aspects of the invention.

### DETAILED DESCRIPTION

Aspects of the present invention relate generally to incident response and recovery operations and, more particularly, to a system, method and computer program product of accelerated major incident response and recovery optimization to reduce latency. In embodiments, the system, method and/or computer program product transforms incident resolution by introducing context-awareness and leveraging historical data effectively to reduce latency in responding to critical issues. This is accomplished by, for example, providing a dynamic context modeling for problem identification, analytics integration and context-aware optimized recovery formulation. By way of more specific example to provide the benefits and advantages herein, aspects of the invention leverage a deterministic and methodical process of identifying patterns and parallels from a time series of plurality of historical incident-solution pairs by, for example, K-means clustering.

In more specific embodiments, the system, method and computer program product provides a technical solution to a technical problem by providing a tool and framework which provides a well-coordinated response process to accelerate the incident resolution and minimize business impact for responding to major incidents. That is, the system, method and computer program product provide an effective and efficient system for responding to major incidents. In aspects of the present invention, the technical solution includes both analytics and cognitive frameworks to analyze historical incidents and source IT environments based on technical and business attributes to guide and recommend the recovery formulation for dynamic and context aware incident resolution. The solution uses both artificial intelligence and machine learning as described further herein.

For example, the system, method and/or computer program product make a unique sequential analysis inference on the integrators of health, telemetry and automation in a customer environment to correlate the identified patterns for recovery formulation. A service continuity deployment evaluation helps to narrow down the optimal resolutions for recovery. By considering context, leveraging acquired knowledge, and evaluating recovery formulation, aspects of the invention enhance the incident resolution process in interconnected and complex environments, while enabling prompt incident handling, efficient resource usage, reduced response time and real-time adaptability for recovery optimization. In this way, a methodical framework for incident resolution guides through steps for finding optimized recovery solutions for remediation thereby reducing mean-time to resolve and providing an advantage over ad-hoc approaches which inevitably lead to delays.

By way of an illustrative example to further define the technical problem and accompanying technical solution provided by aspects of the invention, traditional IT major incident management is often manual and latent in approach and lacks coherent models. For example, traditional approaches often involve following an “ad-hoc” break-fix approach which relies on manual analysis. In implementation, the traditional critical situation management approaches lack the ability to adapt dynamically to changing contexts and fail to consider the broader environment in which incidents occur. This creates several key limitations for modern enterprises including, for example: (i) latent diagnosis; (ii) procedural delays; (iii) prolonged downtimes; and (iv) lack of scalability.

To address these many issues and shortcomings, the technical aspects of the invention correlate data points from diverse integrators including telemetry sources, device health checks, and analysis of historical data, taking into real-time context and dependencies that lead to an enhanced and optimized recovery. These diverse integrators can be referred to as system integrators or infrastructure integrators and are meant to include any combination of the integrators described herein. In this manner, the major incidents can be dealt with in shorter timescales and higher priority, so that there is a faster resolution process for incidents with high business impact. Also, given the urgency of the addressing major incidents, aspects of the invention provide many advantages when tackling the technical problems associated with traditional methods including: (i) minimizing the impact of service interruptions; (ii) soliciting optimal recovery steps for mitigation; (ii) formulating a well thought out recovery plan to resolve an issue; and (iv) diminishing the mean time to resolve issues. Accordingly, aspects of the present invention provide critical incident response services is swift problem identification to handle incidents, crucial for minimizing damage and maintaining operational continuity.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

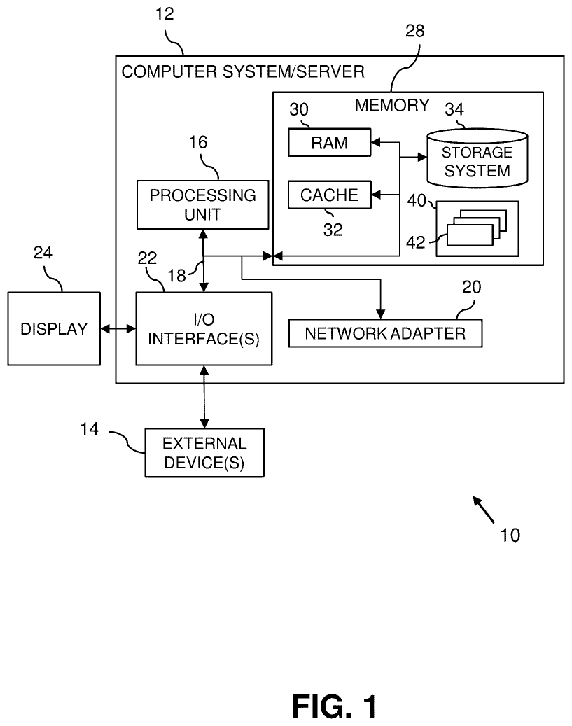

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc. ; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

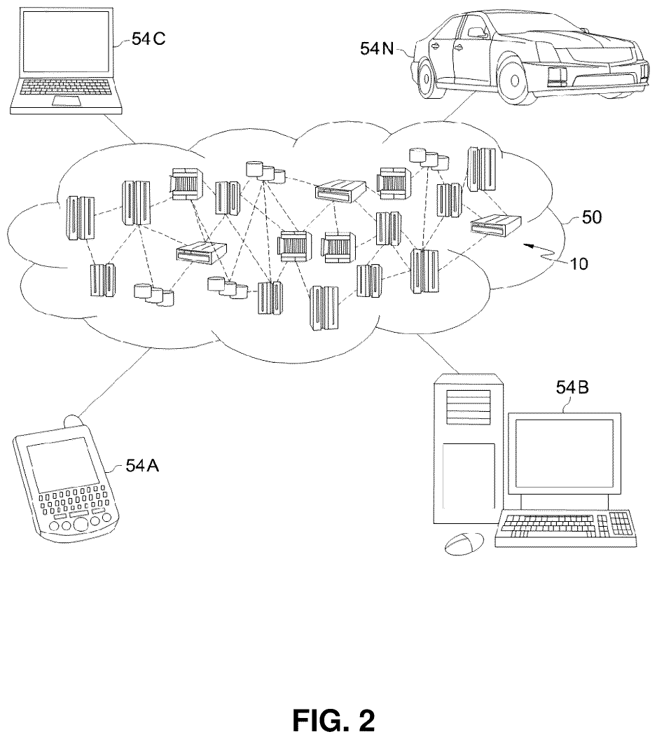

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

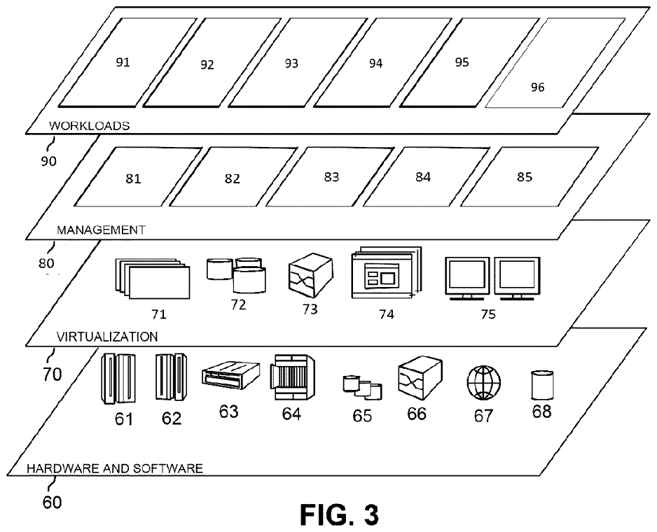

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and response and recovery optimization 96.

Implementations of the invention may include a computer system/server 12 of FIG. 1 in which one or more of the program modules 42 are configured to perform (or cause the computer system/server 12 to perform) one of more functions of the response and recovery optimization 96 of FIG. 3. For example, the one or more of the program modules 42 may be configured to provide an advanced system driven solution designed to assist human responders during major incidents.

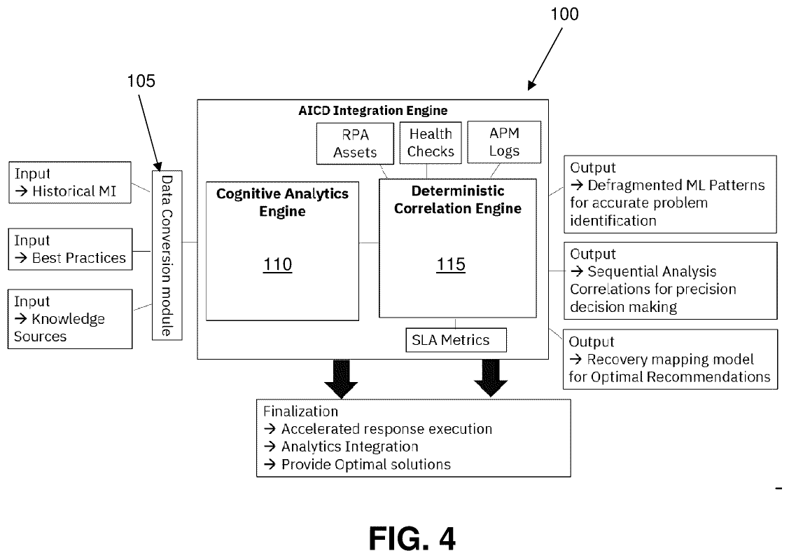

For example, in aspects of the invention, the one or more program modules 42 leverage natural language processing to understand problem context (e.g., system issues related to an IT infrastructure, etc.). For example, the natural language processing will process the different input data noted herein including, for example, unstructured text data, standard operating procedures, outage avoidance recommendations, vendor best practice guidance, different system logs, health checks, telemetry data, proprietary knowledge articles, etc. The one or more program modules 42 will extract relevant details, identify patterns, and categorize incidents and further implement machine learning for providing unique pattern search on unstructured knowledge sources using a cognitive analytical engine as further shown in FIG. 4. The machine learning patterns are extracted and correlated with telemetric, and device health metrics integrated from the affected environment for semantic understanding. As should be understood by those of ordinary skill in the art, semantic textual similarity enabled correlations augment quick identification of problem solution pairs and accelerate retrieval of patterns in response to dynamic contextual queries during critical situations (which may form the grounded data for further deterministic analysis).

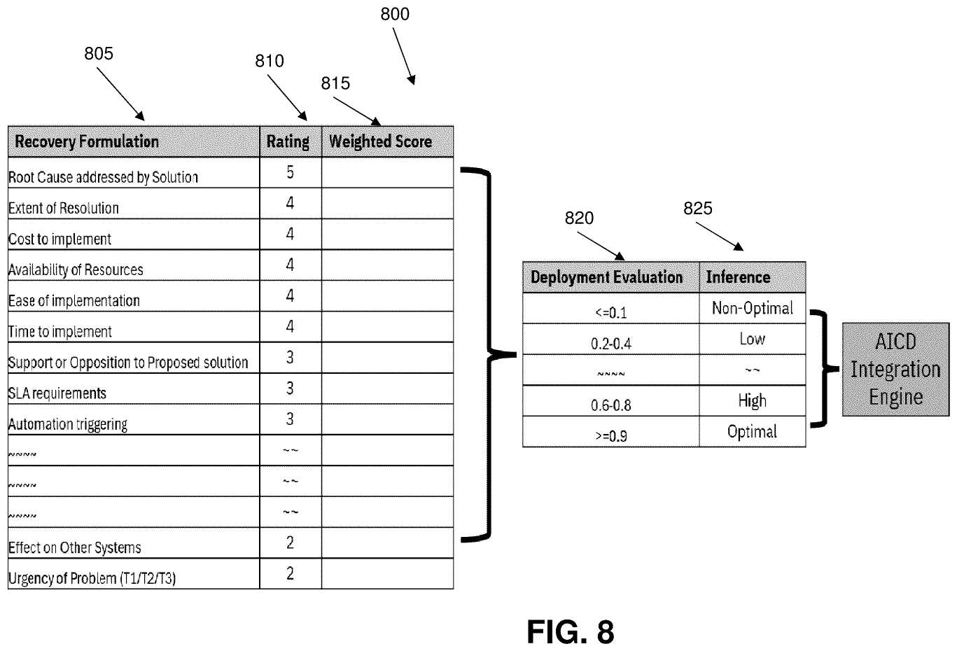

Moreover, with sequential analysis performed on the observable metrics, a weighted inference score can be derived on impact and correlation as shown in FIG. 8 for example. These weighted inference scores assist in recovery formulation on the best matched patterns of incident solution pair which may be collected from defragmented machine learning patterns. For example, a K-means clustering method may be utilized where historical incidents along with unstructured knowledge bases from various sources described herein are assembled uniquely as machine learning defragmented clusters in a continuous process (compared to a onetime activity at the commencement of a project). In embodiments, the machine learning can be grouped after dimensionality reduction and vector embeddings, the output of which helps to improve search responses for homogenous data points within heterogenous datasets.

Also, a recovery action plan is evaluated for deployment using a service continuity mapping model for optimality ranking the solutions. In embodiments, the recovery action plan, e.g., solutions, maps to service level agreements (SLA) and/or business continuity parameters (the SLA and business continuity parameters may generally be referred to as business parameters). Also, by correlating incident attributes with resolved cases, the system, method and computer program product (e.g., one or more program modules 42) not only proposes probable root causes but also recommends optimal remediation plans leading to faster resolution. The root cause of incidents can be determined by, for example, analyzing change records, applying text analytics, and identifying candidate causes based on correlation scores. This approach augments the diagnosis for accurate problem identification and formulation of optimal recovery solutions.

Accordingly, amongst other benefits described herein, aspects of the present invention provide:
(i) faster response times by accelerating decision-making by automating information processing and solution retrieval;
(ii) consistent decision by learning from historical incidents which ensures consistent and informed responses;
(iii) reduced cognitive load such that responders can focus on critical tasks while relying on the processes described herein for information synthesis; and
(iv) improved resource allocation based on incident characteristics.

FIG. 4 shows a block diagram of an exemplary environment in accordance with aspects of the invention. In embodiments, the Accelerated Major Incident Response and Recovery Optimization Engine 100 (e.g., AI Crisis Defuser (AICD) Integration Engine) may be implemented and/or integrated with an IT operational toolchain (e.g., within enterprise applications). For example, in implementation within the toolchain, the Accelerated Major Incident Response and Recovery Optimization Engine 100 ensures the service continuity of business-critical workloads are managed with swift response to disruptions and provides optimal recovery resolutions for completed issues. As one illustrative and non-limiting example, the IT operational toolchain may include a management service comprising a monitoring, automation and observation tool and a regulatory and audit compliance tool as is known in the art. In this implementation, the Accelerated Major Incident Response and Recovery Optimization Engine 100 can be implemented within these services.

The Accelerated Major Incident Response and Recovery Optimization Engine 100 comprises a Data Conversion Module 105, a Cognitive Analytics Engine 110, and a Deterministic Correlation Engine 115, each of which may comprise one or more program modules such as program modules 42 described with respect to FIG. 1. The Accelerated Major Incident Response and Recovery Optimization Engine 100 may include additional or fewer modules than those shown in FIG. 4. In embodiments, separate modules may be integrated into a single module. Additionally, or alternatively, a single module may be implemented as multiple modules. For example, the Data Conversion Module 105 may be a separate module from the Accelerated Major Incident Response and Recovery Optimization Engine 100. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments, the Accelerated Major Incident Response and Recovery Optimization Engine 100 will provide accelerated response execution, analysists integration and provide optimal solutions using the output of the Cognitive Analytics Engine 110 and the Deterministic Correlation Engine 115, mapped with Service Level Agreement (SLA) metrics. As should be understood by those of ordinary skill in the art, SLA metrics are quantifiable standards that help organizations and service providers measure the quality and timeliness of their services to ensure that agreed-upon service levels are met, and to identify areas for improvement.

The Data Conversion Module 105 performs pre-processing of incoming data from disparate repositories of different integrators of information technology (IT) infrastructure including, for example, varying telemetric data, health check metrics and logs. More specifically, the incoming data may include historical data (e.g., historical incident artifacts), best practices inputs, problem root causes and resolution steps stored as clustered knowledge sources, and other knowledge sources. These other knowledge sources may include, for example, unstructured text data, standard operating procedures, outage avoidance recommendations, vendor best practice guidance and other proprietary knowledge articles. These sources may be processed using natural language processing as is known in the art.

The pre-processing may include, for example, data cleansing by noise reduction and personally identifiable information (PII) redaction, data reduction through outlier removal and data transformation through normalization and aggregation. In embodiments, the Data Conversion Module 105 provides the ability to perform dimensionality reduction on the pre-processed input data to reduce the complexity of a model and improve the performance of a learning algorithm, while also using vector embedding to enable the ability to process and identify related data more effectively by representing it as numerical vectors. Also, the Data Conversion Module 105 may continually evolve to create K numbered clusters over unstructured data for defragmented patterns.

The Cognitive Analytics Engine 110 takes the pre-processed data from the Data Conversion Module 105, e.g., the disparate repositories encompassing historical incident artifacts, best practices inputs, problem root causes and resolution steps stored as clustered knowledge sources, etc. In further embodiments, the Deterministic Correlation Engine 120 collects varying telemetric data, health check metrics and automation assets collected from source environments.

As described in more detail herein, the Cognitive Analytics Engine 110 analyzes the inputs for defragmented machine learning patterns with varying problem context with the help of natural language processing (NPL). The Cognitive Analytics Engine 110 may also apply cognitive artificial intelligence to scan for every machine learned pattern of incident solution pairs for the dynamic context presented during critical situations. The Cognitive Analytics Engine 110 may further apply that knowledge to sequential analysis on telemetric data (and other data described herein) within targeted source environments to derive impact correlation inference from weighted scores to identify candidate causes based on, for example, correlation scores (e.g., weighted scores). The Cognitive Analytics Engine 110 also ingests and feeds this information regarding each criterion for service continuity mapping to derive the recovery formulation as further described herein.

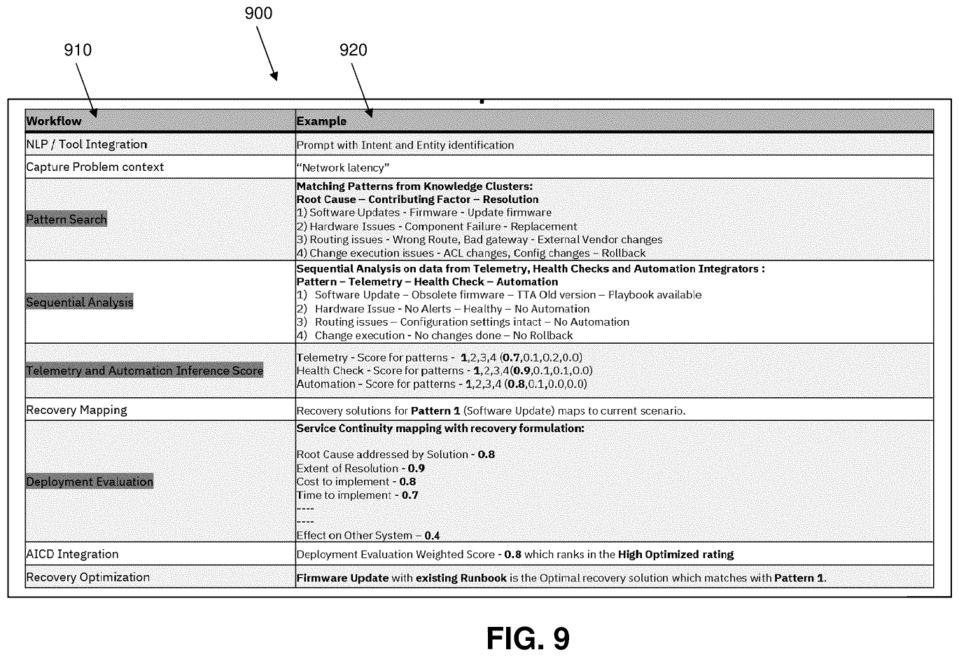

The Deterministic Correlation Engine 115 analyzes the source environment's telemetric data, device health metrics, automation assets, etc. with a sequential analysis inference model. Inputs to the Deterministic Correlation Engine 115 include outputs from the Cognitive Analytics Engine 110, in addition to robotic process automation (RPA) assets, health checks and application performance monitoring (APM) logs, etc. In embodiments, the APM logs may be parsed log messages used with the other data provided herein to generate correlation messages and create incident cases and associated workflow steps as shown in FIG. 9. The RPA assets may include, amongst other examples, credentials, process evaluations, process projects, process board tasks, alert targets, dashboards and/or user API keys. The output of the Deterministic Correlation Engine 115 derives impact correlation inference weighted scores to determine pertinent recovery formulation to any given scenario.

In aspects of the invention, the Deterministic Correlation Engine 115 utilizes the features of machine learning pattern diagnosis, telemetry analytics integration and service continuity-mapped recovery formulation to arrive at the recovery optimization of any source environment. For example, the Deterministic Correlation Engine 115 processes the following datasets and decision logic components:
(i) performs diagnosis by collecting the relevant correlated machine learning patterns associated with problem context;
(ii) performs sequential analysis on the integrators, e.g., health integrators, with derived inference on impact correlations;
(iii) formulates accurate recovery solution mapping with SLA and/or business action parameters; and
(iv) compiles deployment evaluation scores for optimal solutions, e.g., deployment evaluation score to determine optimal solutions for system recovery based on the system issue and the formulated recovery solution.

Moreover, the Deterministic Correlation Engine 115 continually learns from feedback transcribed from each scenario presented during critical situations to evolve and fine tune itself and the resulting solution. The output of the Deterministic Correlation Engine 115 may include defragmented machine learning patterns for accurate problem identification, sequential analysis correlations for precise decision making, and recovery mapping models for optimal recommendations.

In this way, aspects of the invention contribute to successful recovery and restoration solutions for service disruptions during major incidents while reducing prolonged downtimes and saving costs significantly. Also, aspects of the present invention provide enhance service quality in IT operations and reduced time to resolve for major incidents (e.g., mean time to repair, recover, respond, or resolve (MTTR)). More specifically, the following benefits are directly attributed to aspects of the invention:
(i) Cost and time savings from accelerated triage and resolution. This includes reduction in the meantime to resolve MTTR for major incidents, cost savings from faster resolution and reduced downtime, and improved productivity of incident response teams.
(ii) Operational resilience and business continuity benefits. This includes the ability to minimize business impact of major incidents, maintain service quality and SLAs during incidents, and a reduction in customer churn and dissatisfaction due to incidents.
(iii) Knowledge management and continuous improvement capabilities. This includes an enriched knowledge base across functions and business units using the knowledgebase feature, documentation of procedures, root cause analysis, and trend insights, and continuous learning from past incidents to prevent future occurrences is strongly emphasized.
(iv) Deployment flexibility and scalability. This approach integrates with existing IT operation toolchains and incident management tools and provides quick scaling up to handle large volumes of data and incidents.

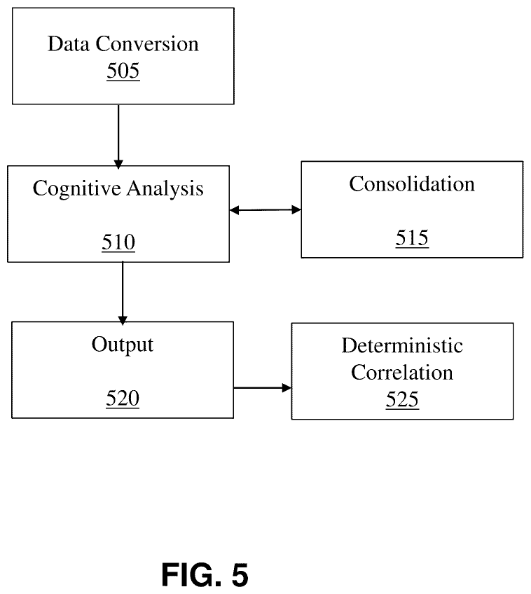

FIG. 5 shows a flowchart of an exemplary method in accordance with aspects of the present invention. Steps of the method may be carried out in the environment of FIG. 4 and are described with reference to elements depicted in FIG. 4. In further embodiments, the flowchart of FIG. 5 can equally represent a block diagram of the present invention.

For example, at step 505, the system (e.g., Data Conversion Module 105) receives input data from disparate databases. The data input may include, for example, historical information (including other major issues and resolutions), recovery steps, root causes, lessons learnt, contributing factors, best practices, in addition or any combination of the other input data described herein. At step 505, the system will perform pre-processing on the input data including, for example, noise reduction, PII redaction, removal of outliers, data aggregation and metadata normalization.

At step 510, the system provides cognitive analysis on the converted data. For example, the Cognitive Analytics Engine 110 may provide processing on the data including, for example, dimensionality reduction on the pre-processed input data to reduce the complexity of a model and improve the performance of a learning algorithm. Additional processing may include, for example, vector embedding to enable the ability to process and identify related data more effectively by representing it as numerical vectors. It should be recognized by those of skill in the art that the dimensionality reduction and the vector embedding may be done in separate modules or engines. Moreover, the Cognitive Analytics Engine 110 may perform grouping of machine learning patterns after dimensionality reduction and vector embeddings, the output of which helps to improve search responses for homogenous data points within heterogenous datasets

At step 515, the data is consolidated by defragmenting the machine learning patterns. This defragmenting may be performed in the Cognitive Analytics Engine 110. For example, a definitive dataset of machine learning clusters by K-means clustering with a distance metric of Cosine similarity can be consolidated to act as grounding data for matched pattern retrieval. The consolidation can be provided in a feedback loop within the Cognitive Analytics Engine 110, as an example.

At step 520, the system outputs the data. This output may include, for example, fine-tuned grounded data for retrieval augmented generation. The grounded data may include clustering with vector embedded dimensionality for semantic correlations, improved search responses for homogenous data points within a heterogenous dataset and accelerated retrieval of patterns in response to dynamic contextual queries.

Vector embeddings are numerical representations of data points that express different types of data, including nonmathematical data such as words or images, as an array of numbers that machine learning (ML) models can process. In embodiments, the machine learning may be, for example, unsupervised machine learning. Semantic correlation is a language structure that contains information about the structure of the language space. It can be used in a variety of ways, including, for example, semantic correlation rules, context and class semantic correlation, generalized relation learning, and/or cross-domain recommendation.

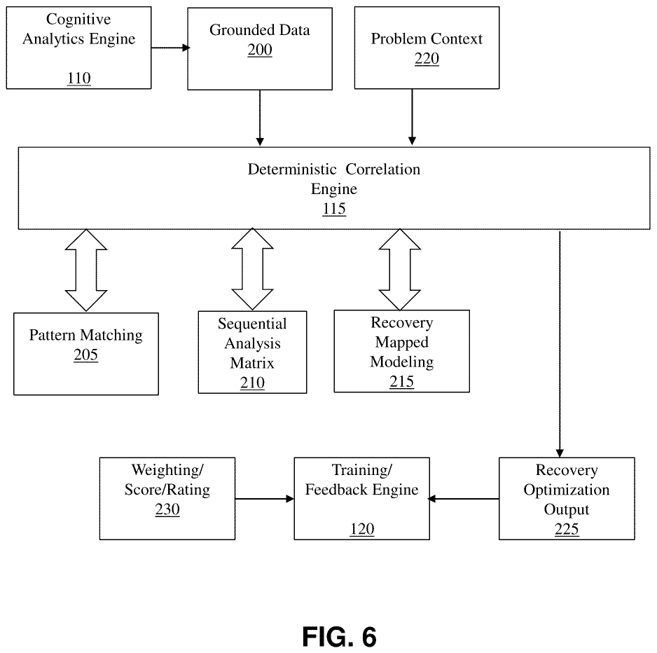

At step 525, the system further processes the output. This processing can be performed by the Deterministic Correlation Engine 115 as further described with respect to FIG. 6.

FIG. 6 shows a block diagram of further aspects of the present invention and particularly focuses on the processing performed by the Deterministic Correlation Engine 115. FIG. 6 can equally represent a flow chart of the processes of the present invention. As with the features of FIG. 5, the steps of the method may be carried out in the environment of FIG. 4.

As shown in FIG. 6, for example, the Cognitive Analytics Engine 110 outputs grounded data 200 such as, vector embedding, semantic correlated, and defragmented machine learning patterns. The grounded data 200 and a problem context 220 (e.g., major incident/system issue) can be analyzed by the Deterministic Correlation Engine 115 to identify a problem, e.g., major incident. This analysis may use pattern matching techniques 205 including, for example, a context query process, a semantic textual similarity process or a correlation and relevance process.

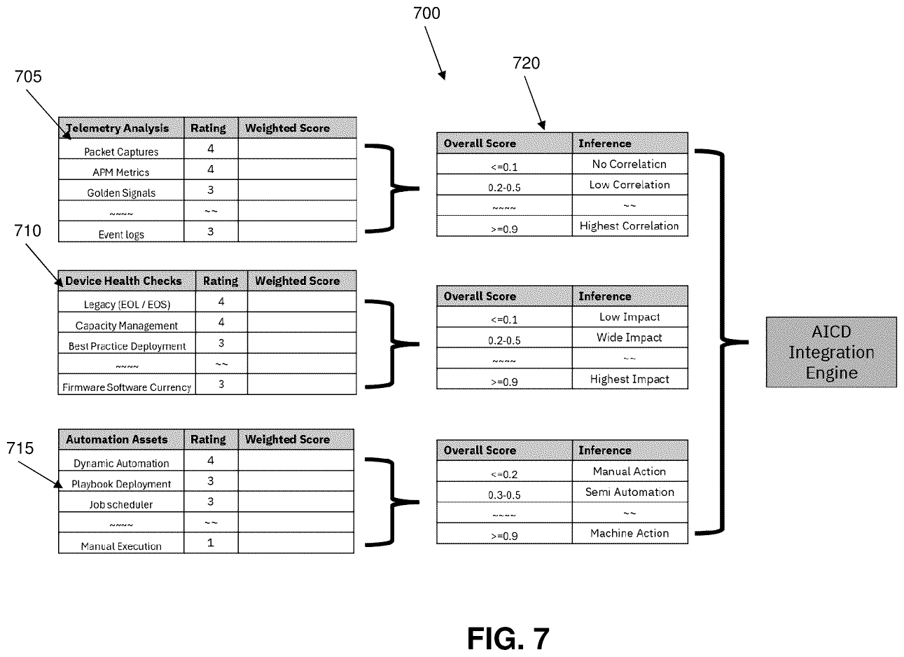

The Deterministic Correlation Engine 115 may also provide analysis integration by a sequential analysis matrix 210. As should be understood by those of skill in the art, a sequential analysis matrix shows the cost of transforming one sequence into another. The matrix 210 is used in sequence analysis, which is a method that aims to minimize the cost of transforming sequences. This may include, for example, using RPA assets, APM logs and health checks, in addition to a sequential analysis and inference matrix. (An example matrix is shown in FIG. 7.) Accordingly, the Deterministic Correlation Engine 115 may provide an optimal recovery methodology by correlating the current outage context with an array of information sources, including clustered knowledge bases, automation assets, telemetry APM logs, health checks, and SLA metrics.

The Deterministic Correlation Engine 115 may also provide deployment evaluation. The deployment evaluation may include generating a recovery mapped modeling 215 which maps SLA metrics, service continuity and recovery formulation. In this way, the Deterministic Correlation Engine 115 performs a deployment evaluation of the formulated solution, aligning it with SLA metrics and business action logic to rank the optimality before relaying the solutions to decision makers. This allows for optimized recovery solutioning and quickly defines response plans for remediation and avoids prolonged downtimes. Also, the service continuity mapping of formulated solutions helps the decision makers to decide, on a continual basis, what segments of their infrastructure services can be quickly restored.

The output of the Deterministic Correlation Engine 115 is a recovery optimization strategy. This recovery optimization includes, for example, precision problem identification, sequential analytics correlation on date from the logs and health checks, human and machine action recovery formulation, deployment evaluation and optimal recovery solutions. This output 225 can be provided to a training and feedback engine 120, which uses the components of the recovery optimization strategy to train datasets and provide additional feedback. For example, the Deterministic Correlation Engine 115 can continually learn from feedback transcribed from each scenario presented during critical situations to evolve and fine tune.

In embodiments, a rating, score or weighting 230 can be provided to the different recovery optimization strategies. In embodiments, the system, method and/or computer program product can use inference scoring, which is a process that uses a trained model to make predictions on unlabeled examples. The inference scoring can include, for example, static inference or dynamic inference methods as is known in the art such that no further explanation is required for a complete understanding of the present invention. In machine learning inference, the host system accepts data input and then delivers the output score from the model to a data destination. The data destination can be a database or any data repository. Downstream applications can then take further action on the scores.

In this way, the Deterministic Correlation Engine 115 utilizes the features of machine learning pattern diagnosis, telemetry analytics integration and service continuity mapped recovery formulation to arrive at the recovery optimization of any source environment. The datasets and decision logic components can be used to:
(i) perform diagnosis by collecting the relevant correlated ML patterns associated with problem context;
(ii) run sequential analysis on health integrators with derived inference on impact correlations;
(iii) formulate accurate recovery solution mapping with SLA and business action parameters; and
(iv) compile deployment evaluation scores for optimal solutions.

FIG. 7 shows an example sequential analysis inference matrix score in accordance with aspects of the invention. This matrix 700 of FIG. 1 may include the use of, for example, RPA assets, APM logs and health checks. For example, in embodiments, the sequential analysis inference matrix score 700 includes a telemetry analysis 705, device health checks 710 and automation assets 715, each with a rating and weighted score. The sequential analysis inference matrix score 700 also includes an overall score and inference score 720 for each of the telemetry analysis 705, device health checks 710 and automation assets 715. In this example, a score below or equal to 0.01 will have no correlations for the telemetry analysis 705, a low impact for the device health checks 710 and a manual action for the automation asset 715. A score between 0.2-0.5 will have a low correlation for the telemetry analysis 705, a side impact for the device health checks 710 and a semi automation inference for the automation assets 715. A score equal to or greater than 0.9 will have a higher correlation for the telemetry analysis 705, a highest impact for the device health checks 710 and a machine action for the automation assets 715.

FIG. 8 shows an example recovery formulation and deployment evaluation scorecard in accordance with aspects of the invention. In embodiments, the recovery formulation and deployment evaluation scorecard 800 may be provided by the Deterministic Correlation Engine 115 to provide optimal solutions. The recovery formulation and deployment evaluation scorecard 800 includes a recovery formulation 805, each with a rating 810 and weighted score 815. The recovery formulation and deployment evaluation scorecard 800 also includes a deployment evaluation 820 and an inference 825. In this example, a score below or equal to 0.01 will be non-optimal. A score between 0.2-0.4 will have a low correlation for the telemetry analysis 805. A score equal to or greater than 0.6-0.8 will have a high inference and a score of 0.9 or greater will have an optimal inference.

FIG. 9 shows a scenario based example of the integration workflow in accordance with aspects of the invention. As shown in FIG. 9, for example, the scenario-based example 900 includes a workflow 910 and an example 920. The workflow 910 includes integration workflow using natural language processing (NLP) that includes receiving user-input text, generating communication tuples, parsing text for IT incidents, and outputting solutions via a virtual agent interface. As should be understood by those of skill in the art, communication tuples refer to tuples in a tuple space or tuples as a way to return multiple values from a method call. In this example, the workflow includes NLP/tool integration, capturing problem context, pattern search, sequential analysis, telemetry and automation interference score, recovery mapping, deployment evaluation integration and recover optimization. The example 920 may be provided for each workflow 910 and may include recommendations such as, for example, software updates, hardware issues, routing issues or change execution, amongst other examples. The examples 920 may also provide inference scores for the different recommendations, etc. The workflows 910 and examples 920 may also process and communicate data across different layers without transformation. The workflows 910 and examples 920 may also be used to create training data, train an NLP classifier model, classify new log statements, in addition to identifying problem statements and presenting them through a dashboard or other user interface represented by the example of FIG. 9.

In view of the above, one of skill in the art would understand that aspects of the present invention help to focus on the selection of the right skillset resources during major incidents. For example, aspects of the present invention resolve incidents faster, with recovery formulation for service restoration. Also, aspects of the present invention provide time-critical decision making during a production failure and more specifically deals with triggering a decision on disaster recover (DR) failover. Moreover, aspects of the present invention provide optimal recovery solutions with weighted inference and deployment evaluation for all scenarios. In for example, implementation, aspects of the invention can also predict new and future incidents with faster incident resolution based on type of severity and historical patterns, in addition to acting on an unprecedented volume, velocity, and variety of data in real time.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
collecting, by a computing device, input data related to an information technology infrastructure;
performing, by the computing device, sequential analysis on the input data to derive an impact on an incident on the information technology infrastructure; and
formulating, by the computer device, recovery solutions of the incident that maps to business parameters.

2. The method of claim 1, wherein the input data comprises infrastructure integrators including at least one of telemetric data, health check metrics or automation assets.

3. The method of claim 2, wherein the input data includes at least one of historical data, best practices, problem root causes or resolution steps stored as clustered knowledge sources.

4. The method of claim 2, wherein the input data is pre-processed including at least one of data cleansing by noise reduction and personally identifiable information (PII) redaction, data reduction through outlier removal or data transformation through normalization and aggregation.

5. The method of claim 4, further comprising performing dimensionality reduction and vector embedding on the pre-processed input data.

6. The method of claim 4, further comprising evolving the input data to create K numbered clusters over unstructured data for defragmented patterns.

7. The method of claim 4, wherein the sequential analysis includes analyzing the input data for defragmented machine learning patterns with varying problem context using natural language processing (NLP).

8. The method of claim 7, wherein the analyzing includes applying cognitive artificial intelligence to scan for machine learned pattern of incident solution pairs for dynamic context presented during the incident.

9. The method of claim 8, further comprising deriving an impact correlation inference from weighted scores to identify candidate causes of the incident.

10. The method of claim 9, further comprising using robotic process automation (RPA) assets and application performance monitoring (APM) logs to derive the impact correlation inference.

11. The method of claim 9, further comprising utilizing machine learning pattern diagnosis, telemetry analytics integration and service continuity-mapped recovery formulation to arrive at a recovery optimization for the incident.

12. The method of claim 1, wherein the computing device includes software provided as a service in a cloud environment.

13. A computer program product comprising one or more computer readable storage media having program instructions collectively stored on the one or more computer readable storage media, the program instructions executable to:
run sequential analysis on health integrators to derive inferences on impact correlations in relation to a system issue;
formulate a recovery solution that maps to at least one of service level agreements (SLA) or business continuity parameters; and
compile a deployment evaluation score to determine optimal solutions for system recovery based on the system issue and the formulated recovery solution.

14. The computer program product of claim 13, wherein the collecting comprises aggregating data clusters using K-Means machine learning to identify potential causes and solutions of the system issue.

15. The computer program product of claim 14, wherein the sequential analysis comprises a sequential analysis of events to assess metrics of system integrators, telemetry data and automation assets and each of their impact and correlation on the system issue.

16. The computer program product of claim 14, wherein the sequential analysis comprises using pattern matching techniques.

17. The computer program product of claim 14, further comprising running the sequential analysis on health integrators to derive inferences on impact correlations in relation to the system issue.

18. The computer program product of claim 14, further comprising determining root causes of the system issue including analyzing change records, applying text analytics, and identifying candidate causes based on correlation scores.

19. The computer program product of claim 14, further comprising using natural language processing to process unstructured text data, standard operating procedures, outage avoidance recommendations, vendor best practice guidance and proprietary knowledge articles to determine a root cause for the system issue.

20. A system comprising:
a processor, a computer readable memory, one or more computer readable storage media, and program instructions collectively stored on the one or more computer readable storage media, the program instructions executable to:
collect input data of an information technology infrastructure;
run sequential analysis on health integrators to derive inferences on impact correlations in relation to system issues related to the information technology infrastructure; and
formulating a recovery solution of the system issues using the sequential analysis that maps to service level agreements (SLA).
